(19) United States
(12) Patent Application Publication
(10) Pub. No.: US 2002/0033334 A1
(43) Pub. Date: Mar. 21, 2002

(54) Electrochemical gas sensor

(76) Inventors: Peter Tschuncky, Lubeck (DE); Frank Mett, Lubeck (DE); Herbert Kiesele, Lubeck (DE)

Correspondence Address: McGLEW AND TUTTLE, P.C., SCARBOROUGH STATION, SCARBOROUGH, NY, 10510-0827, US

(21) Appl. No.: 09/908,287

(22) Filed: Jul. 18, 2001

(30) Foreign Application Priority Data
Sep. 21, 2000 (DE) DE 100 46 778.4-5

(51) Int. Cl. G01N 27/404

(52) U.S. Cl. 204/415; 205/783

(57) ABSTRACT

An electrochemical gas sensor has at least one measuring electrode (5), a reference electrode (11) and an auxiliary electrode (7) in an electrolyte (3) and a diffusion membrane. The diffusion membrane (4) is formed from a polymer (Teflon® AF) containing bis-2,2-trifluoromethyl-4,5-difluoro-1,3-dioxol. The diffusion membrane (4) faces the ambient atmosphere. This gas sensor according provides increased gas-specific measured signal selectivity as well as extremely reduced measured signal response time and increased detection sensitivity

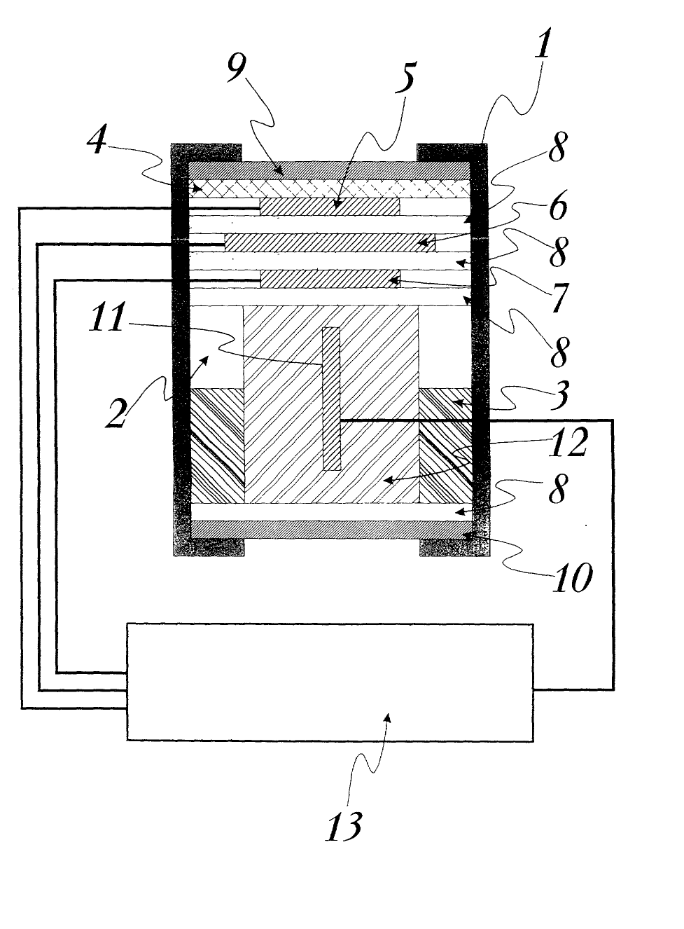

### FIELD OF THE INVENTION

The present invention pertains to an electrochemical gas sensor at least one measuring electrode, a reference electrode and an auxiliary electrode in an electrolyte with a diffusion membrane exposed to the ambient atmosphere.

### BACKGROUND OF THE INVENTION

Such a gas sensor has been known, e.g., from DE 198 45 318 C2, which is used especially as an oxygen sensor.

Electrochemical gas sensors offer the advantage over other gas measuring systems that they are relatively inexpensive and robust and have especially long-term stability and are thus suitable for monitoring gas concentrations even under adverse conditions.

Despite the improvements achieved with this prior-art electrochemical gas sensor in terms of the more rapid and complete conversion of the analyte along with the better long-term stability of the gas sensor, there continues to be a need for improvement.

### SUMMARY AND OBJECTS OF THE INVENTION

It is an object of the present invention to further reduce the response time of an electrochemical gas sensor, on the one hand, and, on the other hand, to detect very low analyte concentrations down to the ppb (parts by billion) range. In addition, it is desirable to attain the highest possible degree of gas-specific signal selectivity for a certain gas in a gas mixture.

According to the invention, an electrochemical gas sensor is provided with at least one measuring electrode, a reference electrode and an auxiliary electrode in an electrolyte. A diffusion membrane is provided exposed to the ambient atmosphere. The diffusion membrane is formed of a copolymer from the monomers bis-2,2-trifluoromethyl-4,5-difluoro-1,3-dioxol and tetrafluoroethylene.

It was surprisingly found that increased, gas-specific measured signal selectivity is achieved, on the one hand, and, on the other hand, both the measured signal response time is extremely reduced and the gas-specific detection sensitivity is increased by at least one order of magnitude by making the diffusion membrane from a polymer containing bis-2,2-trifluoromethyl-4,5-difluoro-1,3-dioxol and especially from a copolymer from the monomers bis-2,2-trifluoromethyl-4,5-difluoro-1,3-dioxol and tetrafluoroethylene, which is available commercially as “Teflon® AF” and is described, e.g., in U.S. Pat. No. 4,754,009 and U.S. Pat. No. 4,935,477. The content of U.S. Pat. No. 4,754,009 and U.S. Pat. No. 4,935,477 are incorporated by reference.

It was possible to observe in the case of the gases O₂ and H₂ and with the above-mentioned special fluoropolymer as the diffusion membrane that reduced measured signal response times and improved measured signal sensitivity can be obtained. The very high rates of permeation of oxygen, but also of some other gases through the diffusion membranes according to the present invention, which were observed compared with conventional materials such as PTFE (polytetrafluoroethylene), lead to markedly shorter (1/10 to 1/100) measured signal response times and to a substantially improved measured signal sensitivity (by a factor of 10) at equal layer thickness of the diffusion membrane, so that very low gas concentrations can also be measured rapidly. On the other hand, electrochemical gas sensors which have unusually thick diffusion membranes with thicknesses of, e.g., 100 μm and thus have a correspondingly higher mechanical stability are provided as an alternative and according to the present invention, without the hitherto usual characteristic measurement properties of the gas sensor, especially the measured signal response time and the measured signal sensitivity, being impaired.

A protective electrode may additionally be provided. The said diffusion membrane may be coated at least partially on one side with a mixture of a precious metal or carbon and a copolymer from the monomers bis-2,2-trifluoromethyl-4,5-difluoro-1,3-dioxol and tetrafluoroethylene alone or mixed with PTFE (polytetrafluoroethylene), which mixture (this coating) forms the measuring electrode. The thickness of the diffusion membrane is advantageously 1 μm to 500 μm. The measuring electrode advantageously has an external diameter of 0.1 mm to 50 mm and especially 2 mm to 20 mm. The coating forming the measuring electrode has an overall thickness of 10 μm to 1,000 μm and especially 50 μm to 300 μm. Precious metal may be used in the mixture forming the measuring electrode including gold, platinum, iridium and/or ruthenium or alloys or mixtures of these precious metals. An additional porous support membrane may be arranged on the diffusion membrane, wherein the support membrane faces the ambient atmosphere and preferably consists of PTFE (polytetrafluoroethylene). Separators impregnated with electrolyte may be present between the electrodes. These separators may be nonwovens (nonwoven elements).

The gas sensor of the invention is particularly useful as a sensor in a process for measurement of the concentrations of the gases oxygen and hydrogen.

Gas sensors of such a design can be used in industrial process analysis and monitoring if a high mechanical stress on the diffusion membrane is unavoidable because of pressure gradients occurring over the diffusion membrane.

Another advantage of the gas sensors according to the present invention with the indicated diffusion membrane without pores is that it retains interfering organic accompanying substances of the analytes to be measured, especially organic solvents.

Based on the different permeation behaviors of the different gases, gas-selective gas sensors can be designed or developed for combinations of gases with different permeabilities.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

The only FIGURE is a sectional view through an electrochemical gas sensor according to the present invention for the measurement of the concentration of oxygen.

### DESCRIPTION OF THE PREFERRED EMBODIMENTS

Referring to the drawings in particular, a sensor housing 1 is provided consisting especially of porous PTFE (polytetrafluoroethylene) to make possible a position-independent pressure equalization with the ambient atmosphere. The housing 1 encloses an electrolyte space 2 for receiving the electrolyte 3, namely, especially sulfuric acid. The diffusion membrane 4 consists of a TEFLON® AF film with a thickness of 1 μm to 50 μm. The measuring electrode 5 is formed in the exemplary embodiment in the form of a layer on the diffusion membrane 4 from a mixture of a precious metal or carbon and a copolymer from the monomers bis-2,2-trifluoromethyl-4,5-difluoro-1,3-dioxol and tetrafluoroethylene alone or mixed with PTFE (polytetrafluoroethylene). This mixture is firmly connected to the diffusion membrane 4. The measuring electrode 5 may also be formed by vapor deposition, sputtering or plasma processes of noble metals including one or more of gold, platinum, iridium, ruthenium. As an alternative, the measuring electrode 5 is prepared as a discrete component from an electrode material containing carbon, such as graphite or glassy carbon, a thin electrolyte layer being provided between the measuring electrode 5 and the diffusion membrane 4 in these cases. A protective electrode 6 and an auxiliary electrode 7, which are separated in a defined manner by separators 8, i.e., nonwovens impregnated with electrolyte, follow behind the measuring electrode 5 from the outside to the inside. The porous support membrane 9 is an independent component made of PTFE (polytetrafluoroethylene), but it may also be welded to the diffusion membrane 4. The rear side of the sensor housing 1 is closed with a porous PTFE disk 10. A metal or metal oxide is used as the material for the reference electrode 11. The reference electrode 11 is accommodated by a porous body 12, preferably one made of glass, which accommodates an electrolyte and guarantees the position-independent uniform wetting of the electrodes by the electrolyte at the same time. The electronic control of the gas sensor and the evaluation of the current produced at the measuring electrode 5 during the reduction of the oxygen are guaranteed by a control and evaluating unit 13, with which the electrodes are electrically contacted.

According to the measurements conducted hitherto, gas sensors according to the present invention are especially suitable for the determination of the concentrations of the gases oxygen and hydrogen.

Typical fields of application of the gas sensors according to the present invention are rapid measurements of the oxygen concentration resolved for individual breaths for medical purposes or the determination of extremely low gas concentrations in the ppm to ppb range in the semiconductor industry or in sewage treatment plants. The process of the invention including using the sensor as described for sensing a particular gas, can be combined with other related process steps.

While specific embodiments of the invention have been shown and described in detail to illustrate the application of the principles of the invention, it will be understood that the invention may be embodied otherwise without departing from such principles.

What is claimed is:

1. An electrochemical gas sensor, comprising:
a measuring electrode;
a reference electrode;
an electrolyte;
an auxiliary electrode in said electrolyte; and
a diffusion membrane exposed to the ambient atmosphere, said diffusion membrane consisting essentially of a copolymer from the monomers bis-2,2-trifluoromethyl-4,5-difluoro-1,3 -dioxol and tetrafluoroethylene.

2. An electrochemical gas sensor in accordance with claim 1, further comprising: a protective electrode.

3. An electrochemical gas sensor in accordance with claim 1, wherein said diffusion membrane is coated at least partially on one side with a mixture of a precious metal or carbon and a copolymer from the monomers bis-2,2-trifluoromethyl-4,5-difluoro-1,3-dioxol and tetrafluoroethylene alone or mixed with polytetrafluoroethylene (PTFE), said mixture forming said measuring electrode.

4. An electrochemical gas sensor in accordance with claim 2, wherein said diffusion membrane is coated at least partially on one side with a mixture of a precious metal or carbon and a copolymer from the monomers bis-2,2-trifluoromethyl-4,5-difluoro-1,3-dioxol and tetrafluoroethylene alone or mixed with polytetrafluoroethylene (PTFE), said mixture forming said measuring electrode.

5. An electrochemical gas sensor in accordance with claim 1, wherein said diffusion membrane has a thickness of 1 μm to 500 μm.

6. An electrochemical gas sensor in accordance with claim 1, wherein said measuring electrode has an external diameter of 0.1 mm to 50 mm.

7. An electrochemical gas sensor in accordance with claim 6, wherein said measuring electrode has an external diameter of 2 mm to 20 mm.

8. An electrochemical gas sensor in accordance with claim 1, wherein the coating forming the measuring electrode has an overall thickness of 10 μm to 1,000 μm.

9. An electrochemical gas sensor in accordance with claim 8, wherein the coating forming the measuring electrode has an overall thickness of 50 μm to 300 μm.

10. An electrochemical gas sensor in accordance with claim 1, wherein measuring electrode is formed of one or more precious metals including one or more of gold, platinum, iridium, ruthenium or consists of alloys thereof.

11. An electrochemical gas sensor in accordance with claim 1, further comprising: an additional porous support membrane arranged on said diffusion membrane, said additional support membrane facing the ambient atmosphere.

12. An electrochemical gas sensor in accordance with claim 11, wherein said additional porous support membrane consists essentially of PTFE (polytetrafluoroethylene).

13. An electrochemical gas sensor in accordance with claim 1, further comprising: separators impregnated with electrolyte disposed between said measuring electrode and said reference electrode and between said reference electrode and said auxiliary electrode.

14. An electrochemical gas sensor in accordance with claim 13, wherein said separators are nonwovens.

15. A process for measuring concentrations of the gases, the process comprising providing a sensor including the steps of:
providing a measuring electrode;
providing a reference electrode disposed relative to said measuring electrode;
providing an electrolyte;
disposing an auxiliary electrode in the electrolyte; and
providing a diffusion membrane exposed to the ambient atmosphere formed essentially of a copolymer from the monomers bis-2,2-trifluoromethyl-4,5-difluoro-1,3-dioxol and tetrafluoroethylene.

16. A process for measuring concentrations of the gases according to claim 15, further comprising using the sensor for the measurement of the concentrations of the gases oxygen and hydrogen.

17. A process for measuring concentrations of the gases according to claim 15, wherein said step of providing a measuring electrode includes coating the diffusion membrane at least partially on one side with a mixture of a precious metal or carbon and a copolymer from the monomers bis-2,2-trifluoromethyl-4,5-difluoro-1,3-dioxol and tetrafluoroethylene alone or mixed with polytetrafluoroethylene (PTFE) to form said measuring electrode.

18. An electrochemical gas sensor, comprising:
a housing having an opening;
a measuring electrode disposed in said housing;
a reference electrode disposed in said housing;
an electrolyte disposed in said housing;
an auxiliary electrode in said electrolyte; and
a diffusion membrane disposed in said housing between said measuring electrode and said opening, exposed to the ambient atmosphere, said diffusion membrane comprising a copolymer from the monomers bis-2,2-trifluoromethyl-4,5-difluoro-1,3-dioxol and tetrafluoroethylene.

19. An electrochemical gas sensor in accordance with claim 18, wherein said diffusion membrane is coated at least partially on one side with a mixture of a precious metal or carbon and a copolymer from the monomers bis-2,2-trifluoromethyl-4,5-difluoro-1,3-dioxol and tetrafluoroethylene alone or mixed with polytetrafluoroethylene (PTFE), said mixture forming said measuring electrode.
